(19) United States
(12) Patent Application Publication
(10) Pub. No.: US 2019/0363330 A1
(43) Pub. Date: Nov. 28, 2019

(54) LEAD FOR BATTERIES AND WOUND BATTERY

(71) Applicant: Panasonic Intellectual Property Management Co., Ltd., Osaka (JP)

(72) Inventors: YUKI SUEHIRO, Osaka (JP); TERUHISA MIURA, Kyoto (JP)

(21) Appl. No.: 16/476,680

(22) PCT Filed: Nov. 17, 2017
(86) PCT No.: PCT/JP2017/041411

§ 371 Date: Jul. 9, 2019

(30) Foreign Application Priority Data
Jan. 31, 2017 (JP) 2017-016257

(51) Int. Cl. H01M 2/26; H01M 10/0587; H01M 10/04; H01M 2/08; H01M 4/66

(52) U.S. Cl. CPC H01M 2/263; H01M 10/0587; H01M 4/661; H01M 10/0431; H01M 2/08; H01M 10/0422

(57) ABSTRACT

A wound battery includes: a battery case having an opening; an electrode group and electrolyte; a sealing body for blocking the opening of the battery case; and a gasket for insulating the sealing body from the battery case. The first electrode is connected to the sealing body via a first current collecting lead, and the second electrode is connected to the battery case via a second current collecting lead. One end of the second current collecting lead is connected to the second electrode, and the other end is pulled out from the end surface of the opening side of the electrode group and is connected to the side-wall inner surface on the opening side of the battery case. The second current collecting lead includes at least one of stainless steel and nickel, and the breaking elongation is 15% or more.

### TECHNICAL FIELD

The present invention relates to a lead for batteries, particularly to a lead for batteries that is pulled out from an electrode group and is connected to the side-wall inner surface on the opening side of a battery case.

### BACKGROUND ART

Recently, with the downsizing of an electronic apparatus, the size of a battery used for the apparatus has been decreased. In the instance of a small battery, a lead for interconnecting an electrode and an external terminal is demanded to be stored in a narrow space. In order to perform the work of connecting the lead and the work of assembling the battery, however, a predetermined lead length is required to be kept. Therefore, the lead is often stored in a bent state in a space in a battery case. When a large impact is applied to the battery due to a drop of the used apparatus in this state, a large stress occurs in a bent portion, and the stress exceeds an allowance stress to sometimes cause a break.

Thus, a lead conductor is proposed which includes 15 mass % or more and 35 mass % or less of Zn, and the remainder being Cu and unavoidable impurities. Here, the lead conductor has a tensile strength of 245 MPa or more and 450 MPa or less, and has a breaking elongation of 40% or more (Patent Literature 1). Such lead conductor has a high bending character and a high impact resistance.

While, it is proposed that the lead is pulled out from the electrode group to the opening side of the battery case and is welded to the side-wall inner surface on the opening side of the battery case (Patent Literature 2).

### CITATION LIST

### Patent Literature

PTL 1: Unexamined Japanese Patent Publication No. 2014-220129

PTL 2: International Patent Publication No. 2012/111061

### SUMMARY OF THE INVENTION

As proposed by Patent Literature 2, when a lead is welded to a side-wall inner surface on the opening side of a battery case, the projecting length of the lead from the end surface of an electrode group is short, and the lead is stored in the battery case while the lead is hardly bent. While, in order to weld the lead to the side-wall inner surface on the opening side of the battery case, a space for inserting a welding tool is required on the opening side of the battery case. When a large impact is applied to the battery due to a drop or the like of a used apparatus, the existence of such a space moves the electrode group in the axial direction of the battery case. In this instance, the stress applied to a lead stored in the battery case in the state in which it is hardly bent is larger than that to a lead stored in the battery case in the bent state. That is because, when the electrode group moves, a large-curvature bending stress or tension is rapidly and locally applied to a lead of a low bending degree. Therefore, the lead can break in a bent portion, or the lead can break in a connection portion between the lead and the battery case.

In view of the above-mentioned problems, a lead for batteries in one aspect of the present disclosure includes at least one of stainless steel and nickel, and has a breaking elongation of 15% or more.

A wound battery of another aspect of the present disclosure includes the following components:

a battery case having an opening;

an electrode group and electrolyte stored in the battery case;

a sealing body for blocking the opening of the battery case; and

a gasket for insulating the sealing body from the battery case.

The electrode group includes: a first electrode; a second electrode having a polarity different from that of the first electrode; and a separator interposed between the first electrode and the second electrode. The first electrode and the second electrode are wound via the separator. The first electrode is connected to the sealing body via a first current collecting lead, and the second electrode is connected to the battery case via a second current collecting lead. One end of the first current collecting lead is connected to the first electrode, and the other end is pulled out from the end surface of the opening side of the electrode group and is connected to the inside of the sealing body. One end of the second current collecting lead is connected to the second electrode, and the other end is pulled out from the end surface and is connected to the side-wall inner surface on the opening side of the battery case. The second current collecting lead is the lead for batteries.

In the aspects of the present disclosure, when a lead pulled out from the electrode group is connected to the side-wall inner surface on the opening side of the battery case, a break of the lead can be suppressed.

### BRIEF DESCRIPTION OF DRAWINGS

FIG. 1 is a diagram schematically showing one example of a first electrode connected to a first current collecting lead, (a) is a plan view, and (b) is a sectional view of the first electrode taken along line Ib-Ib in (a).

FIG. 2 is a diagram schematically showing another example of the first electrode connected to the first current collecting lead, (a) is a plan view, and (b) is a sectional view of the first electrode taken along line IIb-IIb in (a).

FIG. 3 is a diagram schematically showing a second electrode connected to a second current collecting lead, (a) is a plan view, and (b) is a sectional view of the second electrode taken along line IIIb-IIIb in (a).

FIG. 4 is a plan view schematically showing a configuration of an electrode group before winding.

FIG. 5 is a vertical sectional view of a cylindrical battery in accordance with an exemplary embodiment of the present invention.

### DESCRIPTION OF EMBODIMENT(S)

Hereinafter, the breaking elongation and tensile strength are determined by fixing both ends of a lead in the longitudinal direction and by performing a tensile test at a speed of 10 mm/minute in parallel with the longitudinal direction. Here, the breaking elongation indicates, as a value (%) on a percentage basis, the ratio of the permanent elongation (elongation length Δd) after a break to original score distance D in the tensile test. The tensile strength indicates a stress (N/mm²) obtained by dividing the maximum force applied during the tensile test by the cross section of the lead.

The lead for batteries (hereinafter, simply referred to also as “lead”) is a flexible conductor for electrically connecting between the members constituting a battery. For example, the lead is a conductor for electrically connecting between an electrode and a member other than the electrode. The member other than the electrode is a battery case, or a sealing body for blocking the opening of the battery case. The lead is a material obtained by cutting out metal foil into a predetermined shape (for example, strip shape or ribbon shape).

The lead in accordance with the exemplary embodiment of the present invention includes at least one of stainless steel and nickel, and has a breaking elongation of 15% or more. In other words, in the lead for batteries in accordance with the present exemplary embodiment, at least the material and the breaking elongation of the metal foil constituting the lead are characteristic.

When the material of the metal foil includes at least one of stainless steel and nickel, the lead has a tensile strength enough to suppress the break, has a high corrosion resistance, and has a high toughness. Generally, there is a tendency that, as the tensile strength increases, the breaking elongation decreases. While, by using the above-mentioned material, a lead capable of keeping compatibility between the tensile strength and breaking elongation at a high level is obtained. Among others, a lead including stainless steel achieves the tensile strength, breaking elongation, toughness, and corrosion resistance in balance. For refining the material of the lead, a soft material is more desirable than a hard material. The type of the stainless steel is not particularly limited, but SUS304 and SUS316 are preferable because they have a high elongation rate.

A lead cut out from the metal foil can achieve the tensile strength of 300 MPa or more, for example. In order to highly suppress the break of a lead, it is desired to increase the breaking elongation and tensile strength as much as possible. The tensile strength of the lead is more preferably 400 MPa or more, further more preferably 500 MPa or more or 600 MPa or more.

The breaking elongation of the lead needs to be 15% or more, preferably 20% or more, more preferably 40% or more, further more preferably 50% or more. The lead having such large breaking elongation and made of the above-mentioned material has a sufficient flexibility and strength. Therefore, even when a large bending stress and tension are rapidly applied to a lead of a low bending degree, the break of the lead is suppressed.

The metal foil constituting the lead may be made of a single-layer material or may be made of a cladding material having a multi-layer structure. The surface of the single-layer material or cladding material may be plated with a metal such as copper, or may be treated with surface treatment such as chromate treatment.

The single-layer material is made of a metal containing at least one of stainless steel and nickel. The material of the single-layer material may contain other elements other than the stainless steel and nickel, but the content of the other elements is preferably 5 mass % or less, and the material may contain unavoidable impurities.

The cladding material includes at least one of a layer containing stainless steel and a layer containing nickel. The layer containing stainless steel is a layer (hereinafter referred to as “SUS layer”) made of stainless steel that can contain unavoidable impurities, for example. Preferably, the layer containing nickel is a layer that contains 95 mass % or more of Ni, for example, and is a layer including Ni and unavoidable impurities (hereinafter referred to as “pure Ni layer”).

As a specific example of a preferable cladding material, a cladding material including a layer containing stainless steel and a layer containing at least one of nickel and copper is employed. The layer containing at least one of nickel and copper may be the layer containing the nickel, may be an alloy layer of Ni and Cu, or may be a layer containing copper. Preferably, the layer containing copper is a layer that contains 95 mass % or more of Cu, for example, and is a layer including Cu and unavoidable impurities (hereinafter referred to as “pure Cu layer”). Preferably, the alloy layer of Ni and Cu is an alloy layer that contains 95 mass % or more of Ni and Cu, for example, and is a layer including Ni and Cu and unavoidable impurities (hereinafter referred to as “pure Ni/Cu layer”). More specifically, a soft material (Ni—Cu soft material) including a pure Ni layer and a pure Cu layer, and a soft material (Ni-SUS-Cu soft material) including a pure Ni layer, a SUS layer, and a pure Cu layer are preferably.

In a small battery, the thickness of the lead is preferably 30 μm or more and 100 μm or less, more preferably 80 μm or less, further more preferably 50 μm or less. By making the thickness of the lead such small, the lead does not very often apply an unnecessary external force to the electrode group, and a small battery of a high reliability can be obtained.

The width of the lead is preferably 0.5 mm or more and 3.0 mm or less, more preferably 2.5 mm or less, further more preferably 2.0 mm or less. By making the width of the lead such narrow, the lead does not very often apply an unnecessary external force to the electrode group. Furthermore, the lead of the present invention has a sufficient tensile strength, so that the break can be suppressed even when the lead width is decreased, and a small battery of a high reliability can be obtained.

In the cladding material including a layer containing stainless steel, preferably, the content of the layer containing stainless steel is made maximum from the viewpoint of obtaining the lead that achieves the tensile strength, breaking elongation, toughness, and corrosion resistance especially in balance. The content of the layer containing stainless steel or the content of the SUS layer in the cladding material is preferably 50 mass % or more and 99 mass % or less, more preferably 70 mass % or more and 99 mass % or less, for example.

When the cladding material including a layer containing stainless steel includes a layer containing nickel, from the viewpoint of increasing the welding strength of the lead to a battery component, the content of the layer containing nickel or a pure Ni layer in the cladding material is preferably 1 mass % or more and 50 mass % or less, more preferably 3 mass % or more and 30 mass % or less, for example.

When the cladding material including a layer containing stainless steel includes a layer containing copper, from the viewpoint of keeping a high conductivity, the content of the layer containing copper or a pure Cu layer in the cladding material, is preferably 1 mass % or more and 50 mass % or less, more preferably 3 mass % or more and 30 mass % or less, for example.

Metal foil constituting a lead can be manufactured by pasting metal sheets on each other, performing a hot rolling and/or a cold rolling, then performing a heat treatment. By controlling the condition of the heat treatment after the hot rolling or cold rolling, the breaking elongation and tensile strength of the produced metal foil can be controlled.

The hot rolling means a process of rolling the metal sheets at a recrystallization temperature of the metal or more (for example, 500° C. or more and 1300° C. or less). Due to the hot rolling, the composition of the metal foil after the rolling can be fined, and the metal foil having a high workability can be obtained. The cold rolling means a process of rolling the metal sheets at a temperature less than a recrystallization temperature of the metal (for example, 100° C. or less). The cold rolling can promote the work hardening of the metal.

The heat treatment means a treatment of heating metal foil in a nitrogen atmosphere, hydrogen atmosphere, or vacuum in a continuous mode or batch mode. In the continuous mode, a long metal foil is supplied to a heater continuously from one end side, and continuously heated. In the batch mode, for example, metal foil wound in a roll shape is heated in the heater.

The heating temperature in the heat treatment is preferably 700° C. or more and 1200° C. or less. In the above-mentioned range, there is a tendency that the breaking elongation increases as the heating temperature increases. In order to further increase the tensile strength, the heating temperature is preferably 1000° C. or less, more preferably 900° C. or less.

Next, a wound battery of the exemplary embodiment of the present invention includes the following components:

a battery case having an opening;

an electrode group and electrolyte stored in the battery case;

a sealing body for blocking the opening of the battery case; and

a gasket for insulating the sealing body from the battery case.

The electrode group includes: a first electrode; a second electrode having a polarity different from that of the first electrode; and a separator interposed between the first electrode and the second electrode. The first electrode and the second electrode are wound via the separator. The first electrode is electrically connected to the sealing body via a first current collecting lead. The second electrode is electrically connected to the battery case via a second current collecting lead. One end of the first current collecting lead is connected to the first electrode, and the other end is pulled out from the end surface of the opening side of the electrode group and is connected to the inside of the sealing body. One end of the second current collecting lead is connected to the second electrode, and the other end is pulled out from the end surface and is connected to the side-wall inner surface on the opening side of the battery case.

A wound battery having the above-mentioned configuration is appropriate for a small battery. Among others, when the battery case has a cylindrical shape and its outer diameter is 10 mm or less, further 6 mm or less, it is difficult to weld the second current collecting lead to the inner bottom surface of the battery case and it is essential to employ the above-mentioned configuration.

In the instance of the above-mentioned configuration, a space for inserting a welding tool when the second current collecting lead is welded to the battery case is disposed on the opening side of the battery case. The welding tool is a device for performing a resistance welding, for example, and has a pair of electrodes for welding. One electrode for welding is inserted into the battery case from the opening, and the other electrode for welding is disposed outside the opening end so as to face the one electrode for welding. The opening end of the battery case and the second current collecting lead are sandwiched between the pair of electrodes for welding. By making the current flow between the electrodes for welding in this state, the second current collecting lead is welded to the battery case.

Here, when the space is disposed on the opening side of the battery case, applying a large impact to the battery moves the electrode group in the axial direction of the battery case. For example, when the electrode group moves to the opening side of the battery case, the second current collecting lead can locally bend at a large curvature. Furthermore, when an impact of the reverse direction is applied to the battery and the electrode group moves so as to separate from the opening of the battery case, a strong tension is applied to the second current collecting lead. While, using the lead for batteries as the second current collecting lead remarkably suppresses the break of the second current collecting lead.

Hereinafter, the wound battery of the present exemplary embodiment is described in more detail with reference to the accompanying drawings. In this description, the instance that the first electrode is a positive electrode and the second electrode is a negative electrode is shown as an example.

(Positive Electrode)

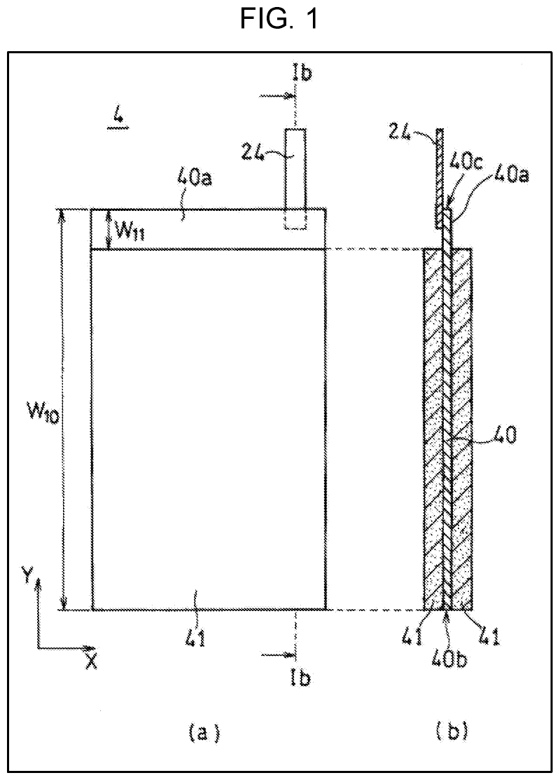

FIG. 1 shows a plan view (a) schematically showing one example of a first electrode (positive electrode) connected to a first current collecting lead (positive-electrode current collecting lead), and a sectional view (b) of the first electrode taken along line Ib-Ib. Positive electrode 4 includes positive-electrode current collector sheet 40, and positive-electrode active material layers 41 formed on the opposite surfaces of positive-electrode current collector sheet 40. Positive-electrode current collector sheet 40 has a rectangular shape. In the present exemplary embodiment, the long-side direction (Y direction in FIG. 1) coincides with the winding axis direction. One end (hereinafter, first end) in the Y direction includes first uncoated portion 40a on which positive-electrode current collector sheet 40 is exposed. First uncoated portion 40a is disposed in a band shape along the first end. One end of strip-shaped positive-electrode current collecting lead 24 is connected to first uncoated portion 40a.

While, at the other end (hereinafter, second end) in the Y direction, positive-electrode current collector sheet 40 is not exposed, and positive-electrode active material layers 41 are formed on the opposite whole surfaces except end surface 40b of the second end. Also at each of the opposite ends of positive-electrode current collector sheet 40 in the short-side direction (X direction in FIG. 1), the opposite whole surfaces are covered with positive-electrode active material layers 41, except the end surfaces and the portion corresponding to the first uncoated portion. Here, “end surface” corresponds to the cross section in the thickness direction formed in cutting a current collector sheet.

Width W₁₀ of positive-electrode current collector sheet 40 in the Y direction needs to be selected in accordance with the length of the battery case or the battery capacity. Width W₁₁ of first uncoated portion 40a needs to be 2 mm to 4 mm inclusive, for example.

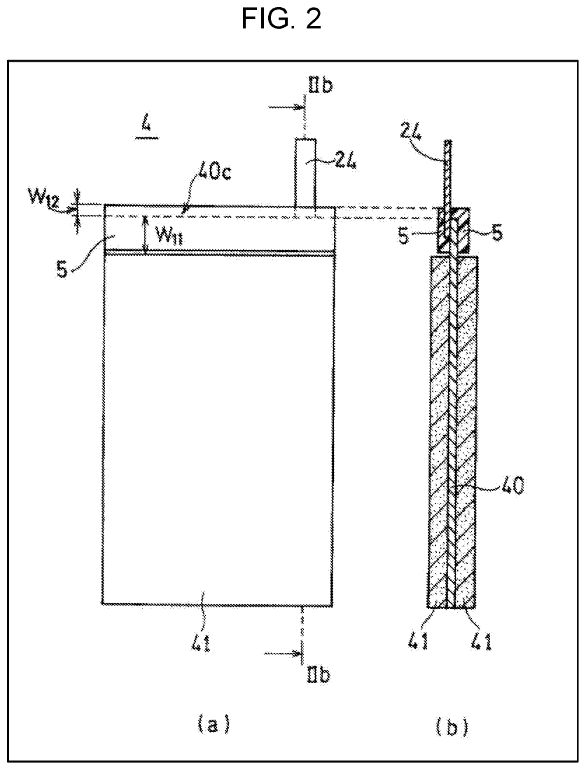

FIG. 2 shows a plan view (a) schematically showing another example of the first electrode (positive electrode) connected to the first current collecting lead (positive-electrode current collecting lead), and a sectional view (b) of the first electrode taken along line IIb-IIb. In FIG. 2, first uncoated portion 40a is covered with insulating layer 5 from the front and rear surfaces. Insulating layer 5 is disposed in a band shape along the first end so as to cover end surface 40c of the first end. When end surface 40c of the first end is covered with insulating layer 5, insulating layer 5 slightly overhangs from end surface 40c of the first end. Thus, the risk that the existence of first uncoated portion 40a causes an internal short circuit is reduced, and the root of positive-electrode current collecting lead 24 is fixed via insulating layer 5.

Overhang width W₁₂ from end surface 40c of the first end of insulating layer 5 is preferably 0.1 mm to 1 mm inclusive, more preferably 0.4 mm to 0.6 mm inclusive. Thus, the effect of fixing the root of positive-electrode current collecting lead 24 via insulating layer 5 is enhanced, and unnecessary increase in the length of the electrode group in the first direction can be avoided.

Insulating layer 5 preferably covers 70% or more of the total area of both surfaces of first uncoated portion 40a, more preferably, insulating layer 5 completely covers first uncoated portion 40a.

Insulating layer 5 is made of a pressure sensitive adhesive containing an insulating resin component. As the pressure sensitive adhesive, for example, a rubber pressure sensitive adhesive, an acrylic pressure sensitive adhesive, a silicone pressure sensitive adhesive, or a urethane pressure sensitive adhesive can be employed. As insulating layer 5, insulating tape may be used. When the insulating tape is used, an operation of covering first uncoated portion 40a with the insulating layer is facilitated. The insulating tape includes an insulating sheet (substrate film), and a pressure sensitive layer disposed on one surface of the insulating sheet. As the insulating sheet, a polypropylene film is used, for example. The thickness of insulating layer 5 is preferably 20% to 50% inclusive of the thickness of the positive-electrode active material layer.

When the cylindrical battery is a lithium-ion battery, metal foil of aluminum or aluminum alloy is employed as positive-electrode current collector sheet 40, for example. The thickness of positive-electrode current collector sheet 40 is not particularly limited, but is preferably 10 μm to 20 μm inclusive.

Positive-electrode active material layer 41 includes a positive-electrode active material, and includes a binder and conductive agent as optional components. As the positive-electrode active material of a lithium-ion secondary battery, a composite oxide containing lithium is preferable, and LiCoO₂, LiNiO₂, or LiMn₂O₄ is employed for example. The thickness of the positive-electrode active material layer is not particularly limited, but is preferably 70 μm to 130 μm inclusive.

As positive-electrode current collecting lead 24, the lead for batteries may be used, but a general lead for batteries may be used. Positive-electrode current collecting lead 24, which is the first current collecting lead, is used for connecting the positive electrode to the inside of the sealing body, and is less likely to cause a break due to an impact in the constitution of the battery. As the general lead for batteries, metal foil of aluminum, aluminum alloy, nickel, nickel alloy, iron, or stainless steel is employed, for example. The thickness of positive-electrode current collecting lead 24 is preferably 10 μm to 100 μm inclusive, more preferably 20 μm to 80 μm inclusive. The shape of positive-electrode current collecting lead 24 is not particularly limited. When the battery case has a cylindrical shape and its outer diameter is 10 mm or less, however, it is preferable that positive-electrode current collecting lead 24 has a strip shape having a width of 0.5 mm to 3 mm inclusive and a length of 3 mm to 10 mm inclusive.

(Negative Electrode)

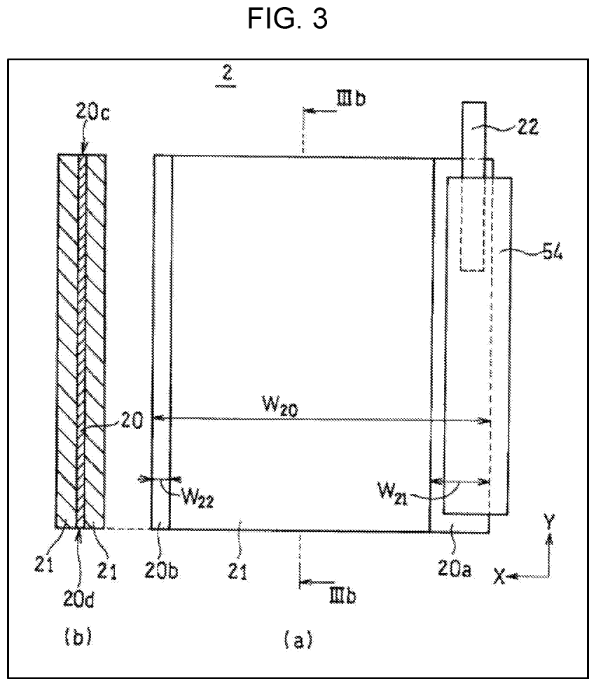

FIG. 3 shows a plan view (a) schematically showing a second electrode (negative electrode) connected to a second current collecting lead (negative-electrode current collecting lead), and a sectional view of the second electrode taken along line IIIb-IIIb. Negative electrode 2 includes negative-electrode current collector sheet 20, and negative-electrode active material layers 21 formed on the opposite surfaces of negative-electrode current collector sheet 20. Negative-electrode current collector sheet 20 has a rectangular shape in which the length in the X direction is set longer than that of positive-electrode current collector sheet 40. One end (hereinafter, first end) in the X direction of negative-electrode current collector sheet 20 includes second uncoated portion 20a on which the negative-electrode current collector sheet is exposed. Second uncoated portion 20a is disposed in a band shape along the first end. Second uncoated portion 20a is connected to one end of strip-shaped negative-electrode current collecting lead 22 by welding.

The other end (hereinafter, second end) of negative-electrode current collector sheet 20 in the X direction also includes a band-shaped third uncoated portion 20b on which negative-electrode current collector sheet 20 is exposed. Such an exposed portion of negative-electrode current collector sheet 20 is disposed for suppressing the peeling of the negative-electrode active material layer.

The opposite ends of negative-electrode current collector sheet 20 in the Y direction are covered with negative-electrode active material layer 21, except end surfaces 20c and 20d at the opposite ends and the portions corresponding to second uncoated portion 20a and third uncoated portion 20b. Thus, the facing surface area of positive-electrode active material layer 41 and negative-electrode active material layer 21 can be sufficiently increased.

Preferably, width W₂₁ of second uncoated portion 20a is 10% to 50% inclusive of width W₂₀ of negative-electrode current collector sheet 20 in the X direction. While, width W₂₂ of third uncoated portion 20b needs to be 1% to 10% inclusive of width W₂₀. Third uncoated portion 20b is not always necessary. A negative-electrode active material layer may be formed in at least a part of the rear surface of each of second uncoated portion 20a and third uncoated portion 20b. Alternatively, the rear surfaces of second uncoated portion 20a and third uncoated portion 20b may be uncoated portions on which the negative-electrode current collector sheets are exposed, similarly to the front surfaces.

When the cylindrical battery is a lithium-ion battery, preferably, metal foil of stainless steel, nickel, copper, copper alloy, or aluminum is employed as negative-electrode current collector sheet 20, for example. The thickness of negative-electrode current collector sheet 20 is not particularly limited, but is preferably 5 μm to 20 μm inclusive.

Negative-electrode active material layer 21 includes a negative-electrode active material, and includes a binder and conductive agent as optional components. As the negative-electrode active material of the lithium-ion battery, metal lithium, a silicon alloy, a carbon material (graphite or hard carbon), a silicon compound, a tin compound, or a lithium titanate compound is employed. The thickness of the negative-electrode active material layer is not particularly limited, but is preferably 70 μm to 150 μm inclusive.

As negative-electrode current collecting lead 22, the lead for batteries is used. The shape of negative-electrode current collecting lead 22 is not particularly limited. When the battery case has a cylindrical shape and its outer diameter is 10 mm or less, however, it is preferable that the shape of negative-electrode current collecting lead 22 is a strip shape having a width of 0.5 mm to 3 mm inclusive and a length of 9 mm to 15 mm inclusive.

In FIG. 3, a connection portion between second uncoated portion 20a and negative-electrode current collecting lead 22 is covered with fixing insulating tape 54. Fixing insulating tape 54 is used for fixing the outermost periphery of the electrode group after winding. Thus, the strength of a connection portion between negative-electrode current collecting lead 22 and negative-electrode current collector sheet 20 is easily kept.

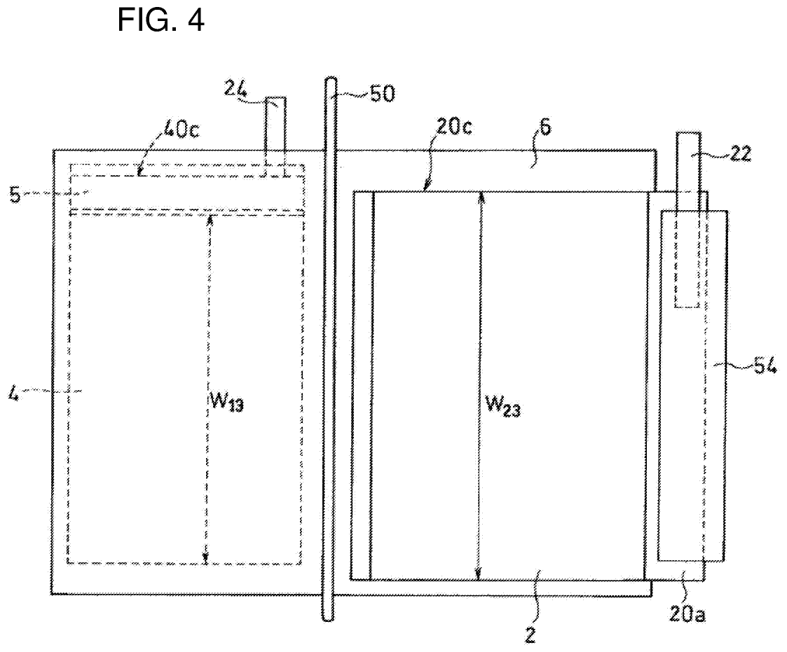

FIG. 4 is a plan view schematically showing the configuration of the electrode group before winding. In the shown example, with respect to separator 6, positive electrode 4 is disposed on the left side and rear side of separator 6, and negative electrode 2 is disposed on the right side and front side of separator 6. Width W₁₃ of positive-electrode active material layer 41 in the winding axis direction (Y direction) is slightly narrower than width W₂₃ of negative-electrode active material layer 21 in the Y direction. Thus, positive electrode 4 and negative electrode 2 are stacked so that positive-electrode active material layer 41 is completely overlaid on negative-electrode active material layer 21. Such a stacked body of positive electrode 4, separator 6, and negative electrode 2 is wound about winding core 50, thereby producing an electrode group.

The opposite ends of separator 6 in the Y direction project more than the corresponding ends of positive electrode 4 and negative electrode 2. Thus, the risk of an internal short circuit is further reduced. End surface 40c of first uncoated portion 40a projects more than end surface 20c of negative-electrode current collector sheet 20. In the above-mentioned positional relation, the position of end surface 20c of negative-electrode current collector sheet 20 faces insulating layer 5 that covers first uncoated portion 40a of positive-electrode current collector sheet 40. Therefore, the risk of an internal short circuit by an end surface of the negative-electrode current collector sheet is greatly reduced. On the projecting side of positive-electrode current collecting lead 24 in the Y direction, the end of insulating layer 5 in the Y direction may be projected more than the corresponding end of separator 6.

One end (second uncoated portion 20a) of negative electrode 2 in the X direction overhangs from separator 6. The overhanging portion faces the side-wall inner surface of the battery case via fixing insulating tape 54.

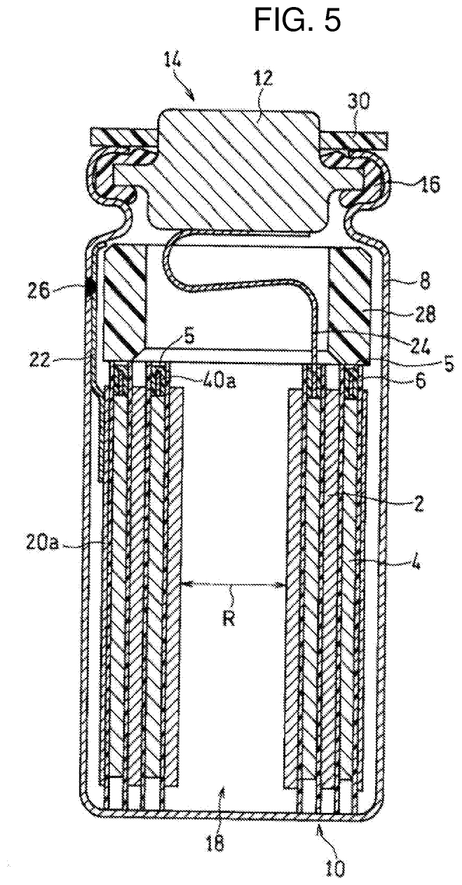

FIG. 5 is a vertical sectional view of a cylindrical battery in accordance with the exemplary embodiment of the present invention. Positive electrode 4 and negative electrode 2 are wound via separator 6 to produce an electrode group. The electrode group, together with an electrolyte (not shown), is blocked in a space that is formed of a bottomed cylindrical battery case 8 and sealing body 12 for sealing the opening in the battery case 8. Hollow portion 18 of a radius of R is formed near the winding axis of the electrode group after winding core 50 is pulled out. The opening end of battery case 8 is crimped to the rim of sealing body 12 via gasket 16. In the shown example, insulating ring member 30 is disposed on the rim of sealing body 12, and insulation between battery case 8 and sealing body 12 is kept.

Both of negative-electrode current collecting lead 22 and positive-electrode current collecting lead 24 are disposed on the opening side of battery case 8. In other words, one end of positive-electrode current collecting lead 24 is connected to positive electrode 4, and the other end is pulled out from the end surface of the opening side of the electrode group and is connected to the inside of sealing body 12. While, one end of negative-electrode current collecting lead 22 is connected to negative electrode 2, and the other end is pulled out from the end surface of the opening side of the electrode group and is connected to the side-wall inner surface of the opening side of battery case 8 by resistance welding. The outer surface of the bottom of battery case 8 serves as negative electrode terminal 10, and the outer surface of sealing body 12 serves as positive electrode terminal 14. Furthermore, FIG. 5 omits fixing insulating tape 54.

In order to bring negative-electrode current collecting lead 22 into contact with the side-wall inner surface of battery case 8, an electrode for welding used for performing the resistance welding needs to be inserted into the battery case from the opening. Therefore, a space for inserting the electrode for welding is disposed on the opening side of battery case 8. In this space, for example, insulating ring-shaped intermediate member 28 is disposed. Thus, the movement of the electrode group in the winding axis direction is generally limited. Intermediate member 28 may be integrated with gasket 16. Positive-electrode current collecting lead 24 is derived to the inner surface of sealing body 12 through a hollow portion of intermediate member 28.

In the instance of the above-mentioned configuration, in order to perform the work of connecting positive-electrode current collecting lead 24 to the inner surface of sealing body 12 and the work of blocking the opening of battery case 8 with sealing body 12, positive-electrode current collecting lead 24 needs to have a predetermined lead length. Therefore, positive-electrode current collecting lead 24 is stored in a bent state in the space in the battery case

While, negative-electrode current collecting lead 22 is welded to the side-wall inner surface of battery case 8, so that the projecting length of negative-electrode current collecting lead 22 from the end surface of the electrode group may be short. Therefore, negative-electrode current collecting lead 22 hardly bents, and is stored in battery case 8 so as to be sandwiched between the outermost periphery of the electrode group and a side wall of battery case 8. Therefore, when the electrode group moves in the axial direction of the battery case due to a large impact such as a drop of a used apparatus, the following phenomenon occurs:

a large-curvature bending stress rapidly and locally occurs in negative-electrode current collecting lead 22; or

a large tension is applied between welding point 26 produced by resistance welding and the connection portion between second uncoated portion 20a and negative-electrode current collecting lead 22.

While, in the instance in which the lead for batteries of the exemplary embodiment of the present invention is used as negative-electrode current collecting lead 22, even when such stress is applied a plurality of times, the break of negative-electrode current collecting lead 22 can be suppressed.

(Separator)

As separator 6, for example, a resin-made microporous film, or a nonwoven fabric is employed. As the resin, a polyolefin resin such as polypropylene or polyethylene; a polyamide resin; and/or a polyimide resin can be employed, for example. The thickness of the separator is preferably 5 μm to 40 μm inclusive or 5 μm to 30 μm inclusive.

(Electrolyte)

An electrolyte can be appropriately selected in accordance with the type of the battery. The electrolyte includes a solvent, and a solute (supporting electrolyte) dissolved in the solvent. The electrolyte may be in a liquid state, or a gel state. For example, in a lithium-ion secondary battery, as the supporting electrolyte (or lithium salt), lithium salt of a fluorine-containing acid [lithium hexafluorophosphate (LiPF₆), lithium tetrafluoroborate (LiPF₄), or lithium trifluoromethanesulfonate (LiCF₃SO₃)] is employed. As the solvent, a non-aqueous solvent is employed. As the non-aqueous solvent, for example, cyclic carbonate such as propylene carbonate (PC) or ethylene carbonate (EC); chain carbonate such as dimethyl carbonate, diethyl carbonate, or ethyl methyl carbonate (EMC); chain ether; cyclic ether; or lactone is employed. The concentration of the supporting electrolyte in the electrolyte is not particularly limited, and is 0.5 mol/L to 2 mol/L inclusive, for example.

(Battery Case)

Battery case 8 includes an opening and has a bottomed cylindrical shape having an outer diameter of 10 mm or less, preferably 6 mm or less, for example. The thickness (maximum thickness) of the bottom of battery case 8 is for example 0.08 mm to 0.2 mm inclusive, preferably 0.09 mm to 0.15 mm inclusive. The thickness (maximum thickness) of the side wall of the battery case is for example 0.08 mm to 0.2 mm inclusive, preferably 0.08 mm to 0.15 mm inclusive.

Preferably, battery case 8 is a metal can. As the material constituting battery case 8, aluminum, aluminum alloy, iron, or iron alloy (containing stainless steel) can be employed, for example. The battery case may be plated with nickel or the like as necessary.

(Sealing Body)

The shape of the sealing body is not particularly limited, and a disk shape or a shape (hat shape) in which the central part of a disk projects in the thickness direction can be employed, for example. As the material of the sealing body, aluminum, aluminum alloy, iron, or iron alloy (containing stainless steel) can be employed, for example.

Hereinafter, the present invention is specifically described on the basis of examples and comparative examples. However, the present invention is not limited to the following examples.

### Example 1

A cylindrical battery (cylindrical lithium-ion secondary battery) shown in FIG. 5 is produced in accordance with the following procedure.

(1) Production of Positive Electrode

A positive-electrode mixture slurry is prepared by adding N-methylpyrrolidone (NMP) as a dispersion medium to the following components:

100 pts·mass of lithium nickel acid as a positive-electrode active material;

4 pts·mass of acetylene black as a conductive agent; and

4 pts·mass of polyvinylidene fluoride (PVdF) as a binder, and by mixing them.

A positive-electrode active material layer is formed and a positive electrode (thickness of 0.14 mm) is obtained, in the following steps:

applying the positive-electrode mixture slurry to the opposite surfaces of an aluminum foil (thickness of 15 μm) as a positive-electrode current collector;

drying them; then

compressing them in the thickness direction.

A first uncoated portion having no positive-electrode active material layer is disposed in the positive electrode along the width direction of the positive electrode. One end of a ribbon-shaped aluminum-made positive-electrode current collecting lead (width of 1.0 mm and thickness of 50 μm) is connected to the first uncoated portion. Then, an insulating adhesive tape is pasted on the first uncoated portion to produce an insulating layer.

(2) Production of Negative Electrode

A negative-electrode mixture slurry is prepared by mixing the following components:

100 pts·mass of artificial graphite powder as a negative-electrode active material;

1 pts·mass of styrene-methacryrate-butadiene copolymer as a binder; and

1 pts·mass of carboxymethyl cellulose (CMC) as a thickener, and by dispersing the obtained mixture in deionized water.

A negative-electrode active material layer is formed and a negative electrode (thickness of 0.15 mm) is obtained, in the following steps:

applying the negative-electrode mixture slurry to the opposite surfaces of a copper foil (thickness of 10 μm) as a negative-electrode current collector;

drying them; then

compressing them in the thickness direction.

A second uncoated portion that does not have the negative-electrode active material layer on either surface is formed in a portion corresponding to the outermost periphery of the electrode group of the negative electrode. One end of a ribbon-shaped predetermined negative-electrode current collecting lead (width of 1.5 mm and thickness of 50 μm) is connected to the second uncoated portion. In this instance, a Ni-SUS-Cu soft material is used for the negative-electrode current collecting lead. The contents of the pure Ni layer, SUS layer, and pure Cu layer are 10 mass %, 80 mass %, and 10 mass %, respectively. The breaking elongation and tensile strength are 60% and 700 MPa, respectively.

(3) Production of Electrode Group

A band-shaped separator is inserted into a slit portion of a winding core (columnar shape having a diameter of 0.8 mm) and is folded at the slit portion to create a two-ply state. The separator, the positive electrode, the negative electrode are made to overlap each other so that the separator is interposed between the positive electrode and the negative electrode, thereby making the positive-electrode active material layer face the negative-electrode active material layer. In this state, the positive electrode, the negative electrode, and the separator are wound about the winding core to produce an electrode group. Then, the winding core is pulled out, and winding stop tape is pasted on a winding end to fix the electrode group. The positive-electrode current collecting lead and the negative-electrode current collecting lead are extended from the end surface (end surface located on the opening side in the battery case) of the electrode group.

(4) Preparation of Non-Aqueous Electrolyte

A non-aqueous electrolyte is prepared by dissolving LiPF₆ in a mixed solvent containing EC and EMC at a mass ratio of 1:1. The concentration of LiPF₆ in the non-aqueous electrolyte is set at 1.0 mol/L.

(5) Production of Cylindrical Battery

The electrode group is inserted into the bottomed cylindrical battery case, and the other end of the negative-electrode current collecting lead is connected to the side-wall inner surface of the battery case by resistance welding. Here, the battery case is formed from a nickel-plated iron plate, and has an opening. An insulating ring-shaped intermediate member is disposed in the upper part of the electrode group. Then, the other end of the positive electrode lead pulled out from the electrode group is passed through a hole in the intermediate member, and is connected to the inner surface of a sealing body having a gasket on its rim. A predetermined amount of non-aqueous electrolyte is injected into the battery case, and then the opening of the battery case is sealed by the sealing body. Thus, battery A1 (height of 30 mm) having a nominal capacity of 30 mAh is obtained. A total of three similar batteries A1 are produced.

[Evaluation]

The obtained battery is dropped from a height position of 1 m to the ground five times so that the winding axis of the electrode group is directed vertically and the opening side of the battery case is directed downward. Then, the direction of the battery is reversed so as to turn the opening side upward, and the battery is dropped five times as discussed above. These operations are used as one set and are repeated, and the total number of sets (N: average of three batteries) until the negative-electrode current collecting lead breaks is examined.

### Example 2

Battery A2 is produced as in example 1 except that the material of the negative-electrode current collecting lead is changed to a Ni—Cu soft material, and battery A2 is evaluated. The contents of the pure Ni layer and pure Cu layer are 70 mass % and 30 mass %, respectively. The breaking elongation and the tensile strength are 20% and 330 MPa, respectively.

### Example 3

Battery A3 is produced as in example 1 except that the material of the negative-electrode current collecting lead is changed to a Ni-SUS-Cu hard material, and battery A3 is evaluated. The contents of the pure Ni layer, SUS layer, and pure Cu layer are 10 mass %, 80 mass %, and 10 mass %, respectively. The breaking elongation and the tensile strength are 17% and 1000 MPa, respectively.

### Comparative Examples 1 to 3

Batteries B1 to B3 are produced as in example 1 except that the negative-electrode current collecting lead shown in Table 1 is used.

TABLE 1

| | | Breaking | Tensile | Number of |
|---|---|---|---|---|
| Battery | Material | elongation (%) | Strength (MPa) | sets N |
| A1 | Ni-SUS-Cu | 60 | 700 | 12 |
| | soft material | | | |
| A2 | Ni—Cu | 20 | 330 | 8 |
| | soft material | | | |
| A3 | Ni-SUS-Cu | 17 | 1000 | 6 |
| | hard material | | | |
| B1 | Ni—Cu | 1 | 600 | 1 |
| | hard material | | | |
| B2 | Ni-SUS | 7 | 650 | 4 |
| | soft material | | | |
| B3 | Pure Ni | 13 | 370 | 3 |
| | semi-hard | | | |
| | material | | | |

As shown in table 1, it is examined that the negative-electrode current collecting leads of examples 1 to 3 have a high resistance to a drop impact, and the break is remarkably suppressed.

### INDUSTRIAL APPLICABILITY

In the exemplary embodiment of the present invention, the break of a lead for batteries is suppressed even when a battery drops, and a high quality of the battery can be kept. The lead for batteries can be appropriately used for a battery serving as a power source of various portable electronic apparatuses.

### REFERENCE MARKS IN THE DRAWINGS

2 negative electrode (second electrode)
4 positive electrode (first electrode)
5 insulating layer
6 separator
8 battery case
10 negative electrode terminal
12 sealing body
14 positive electrode terminal
16 gasket
18 hollow portion
20 negative-electrode current collector sheet
20a second uncoated portion
20b third uncoated portion
21 negative-electrode active material layer
22 negative-electrode current collecting lead (second current collecting lead)
24 positive-electrode current collecting lead (first current collecting lead)
26 welding point
28 intermediate member
30 ring member
40 positive-electrode current collector sheet
41 positive-electrode active material layer
40a first uncoated portion
50 winding core
54 fixing insulating tape

1. A lead for batteries comprising at least one of stainless steel and nickel, wherein a breaking elongation of the lead is 15% or more.

2. The lead for batteries according to claim 1, wherein
a tensile strength of the lead is 300 MPa or more.

3. The lead for batteries according to claim 1, wherein
the lead is configured of a cladding material member including at least stainless steel.

4. The lead for batteries according to claim 3, wherein
the cladding material member includes a layer containing stainless steel and a layer containing at least one of nickel and copper.

5. The lead for batteries according to claim 1, wherein
a thickness of the lead is 30 μm or more and 100 μm or less.

6. The lead for batteries according to claim 1, wherein
a width of the lead is 0.5 mm or more and 2.0 mm or less.

7. A wound battery comprising:
a battery case including an opening;
an electrode group and an electrolyte that are stored in the battery case;
a sealing body configured to block the opening of the battery case; and
a gasket configured to insulate the sealing body from the battery case,
the electrode group including:
a first electrode;
a second electrode having a polarity different from a polarity of the first electrode; and
a separator interposed between the first electrode and the second electrode,
wherein the first electrode and the second electrode are wound via the separator,
wherein the first electrode is coupled to the sealing body via a first current collecting lead,
wherein the second electrode is coupled to the battery case via a second current collecting lead,
wherein a first end of the first current collecting lead is coupled to the first electrode, and a second end of the first current collecting lead is pulled out from an end surface of an opening side of the electrode group and is coupled to an inside of the sealing body,
wherein a first end of the second current collecting lead is coupled to the second electrode, and a second end of the second current collecting lead is pulled out from the end surface and is coupled to a side-wall inner surface of the opening side of the battery case, and
wherein the second current collecting lead is the lead for batteries according to claim 1.

8. The wound battery according to claim 7, wherein
the battery case has a cylindrical shape having an outer diameter of 10 mm or less.
